(19) United States
(12) Patent Application Publication
(10) Pub. No.: US 2011/0221901 A1
(43) Pub. Date: Sep. 15, 2011

(54) Adaptive Scene Rendering and V2X Video/Image Sharing

(75) Inventors: Fan Bai, Ann Arbor, MI (US); Wende Zhang, Shelby Township, MI (US); Cem U. Saraydar, Royal Oak, MI (US)

(73) Assignee: GM GLOBAL TECHNOLOGY OPERATIONS, INC., Detroit, MI (US)

(21) Appl. No.: 12/721,801

(22) Filed: Mar. 11, 2010

(51) Int. Cl. H04N 7/18; G06K 9/00

(52) U.S. Cl. 348/148; 382/104; 348/E07.085

(57) ABSTRACT

A method is provided for video sharing in a vehicle-to-entity communication system. Video data is captured by an image capture device of an event remote from a source entity. A spatial relationship is determined between a location corresponding to the captured event and a location of a remote vehicle. A temporal relationship is determined between a time-stamp of the captured scene data and a current time. A utility value is determined as a function of the spatial relationship and the temporal relationship. A network utilization parameter of a communication network is determined for broadcasting and receiving the scene data. A selected level of compression is applied to the captured scene data as a function of the utility value and available bandwidth. The compressed scene data is transmitted from the source entity to the remote vehicle.

### BACKGROUND OF INVENTION

An embodiment relates generally to vehicle-to-entity communications.

Vehicle Ad-Hoc Networks (VANETs) are a form of mobile communication that provides communications between nearby vehicles, or between vehicles and nearby fixed equipment typically referred to as roadside equipment (RSE) or portable devices carried by pedestrians. The objective is to share information to provide safety and non-safety information relating to events occurring along a road of travel. This can be viewed as a warning message or a situation-awareness message to other vehicles so remote vehicles are informed of the events in the surrounding area before remote vehicles experience any repercussions from the events. For example, a remote vehicle may be notified of a collision or stopped traffic well before the driver of the vehicle enters the location where the driver would become visually aware of the collision or stopped traffic. This allows the driver of the remote vehicle to take precautions when entering the area.

An issue with broadcasting data within a Vehicle Ad-Hoc Network is the lack of bandwidth resource in VANETs and potentially large size of data transmitted between vehicles. This leads to network congestion, which could significantly degrade the performance of services render via VANETs. Moreover, sometime information received by another vehicle may not be pertinent to the receiving vehicle; however, the size of the data packet transmitted may be computationally demanding on the receiving device. This is burdensome particularly when the data packet received is not of great importance to the receiving vehicle. Such messages having low importance to the receiving vehicle act as a bottleneck and may hinder the reception of messages that are of greater importance to the receiving vehicle.

### SUMMARY OF INVENTION

An advantage of an embodiment is the adaptive selection of video compression and image abstraction that is applied to a captured video or image transmitted to a remote vehicle. The adaptive selection of video compression and image abstraction is based on a distance to the captured event, an elapsed time since the event was captured, and a network utilization parameter reflecting the resource usage of the underlying communication network. As a result, the data shared for remote entities in close proximity to the event are provided with richer scene information (e.g., live video or images) in comparison to those remote entities that located further from the event.

An embodiment contemplates a method for scene information sharing in a vehicle-to-entity communication system. Video or image data is captured by an image capture device equipped on a source entity close to an event, and a remote entity interested in obtaining a content of scene (video/image) data is far away from the event. A spatial relationship is determined between a location corresponding to the captured event and a location of a remote vehicle. A temporal relationship is determined between a time-stamp of the captured scene data and a current time. A utility value is determined as a function of the spatial relationship and the temporal relationship. A network utilization parameter of a communication network is determined for adjusting the compression quality and rate of the scene data. A selected level of compression is applied to the captured scene data as a function of the utility value and available bandwidth. The compressed scene data is transmitted from the source entity to the remote vehicle.

An embodiment contemplates a vehicle-to-entity communication system having adaptive scene compression for video/image sharing between a source entity and a remote vehicle. An image capture device of the source entity captures scene (video/image) data in the vicinity of a source entity. An information utility module determines a utility value that is a function of a spatial relationship between a location of the captured event and a location of the remote vehicle and a temporal relationship between a time-stamp of the captured scene data and a current time. A network status estimation module determines a network utilization parameter of a communication network. A processor applies a selected amount of compression to the captured scene data as a function of the utility value and the network utilization parameter of the communication network. A transmitter transmits the compressed scene data to the remote vehicle either in a single-hop manner or in a multi-hop relay manner.

### BRIEF DESCRIPTION OF DRAWINGS

FIG. 1 is a block diagram of a vehicle-to-entity communication system having adaptive scene compression for scene sharing.

FIG. 2 is a graphical representation of a spatial relationship curve.

FIG. 3 is a graphical representation of a temporal relationship curve.

FIG. 4 is a geographical grid illustrating exemplary broadcast regions.

FIG. 5 is a block diagram of varying levels of scene compression and scene abstraction.

FIG. 6 is a flowchart of a method for adaptive scene compression.

### DETAILED DESCRIPTION

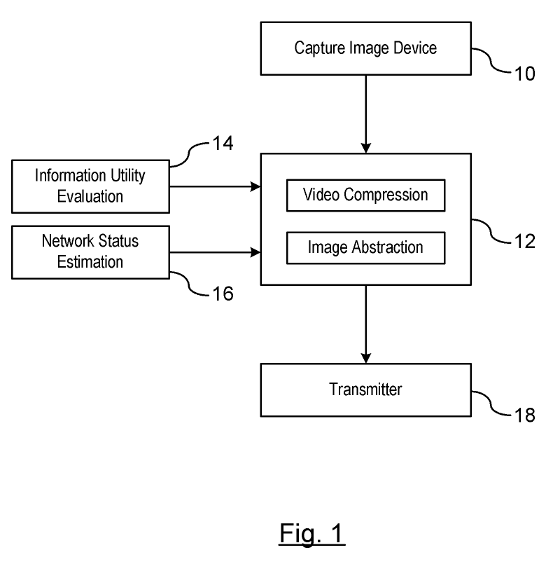

There is shown in FIG. 1 a vehicle-to-entity communication system having adaptive scene compression for image sharing. It understood that the term “image sharing” is meant to include, but is not limited to, video content as well as still image content. The system includes an image capture device 10 for capturing video images of events occurring in proximity to a source entity. The source entity may include a vehicle or equipment that is fixed at a location (e.g., roadside entity). The image capture device may include, but is not limited to, a video recorder. The image capture device 10 preferably records high quality imaging which can be compressed from its high quality captured state.

A processor 12 receives the raw scene data and applies compression to the captured raw scene data (e.g., video/images). The amount of compression is determined based on inputs provided from an information utility evaluation module 14 and a network status estimation module 16. A transmitter 18 is provided for transmitting the compressed scene data or scene abstraction data to the remote vehicle in a single hop mode or a multi-hop mode. Factors involved in the transmission scheme are determined by the entropy of image data and transmission efficiency. For example, a content with high information entropy (e.g., rich content/high resolution) may contain high data volume, resulting in a low data transmission efficiency, whereas a content with low information entropy (e.g., poor content/low resolution) may contain low data volume, resulting in high data transmission efficiency.

The information utility evaluation module 14 determines a utility value that is used by the processor for determining the level of compression. The utility value is a function of a spatial relationship between a location corresponding to the event captured by the image capture device 10 and a location of a remote vehicle receiving the compressed scene data. The utility value is also determined as a function of the temporal relationship between the time the event was captured by the image capture device 10 and the current time.

The spatial relationship may be determined by the position of the remote vehicle and the position corresponding to the location where video/image data is captured. The position of the remote vehicle may be determined by a global positioning system device (e.g., vehicle GPS device) or other positioning means. Remote vehicles in a vehicle-to-entity communication system commonly include their global position as part of a periodic status beacon message.

The temporal relationship is determined by the elapsed time since the event was captured by the image capture device 10. The captured image data is commonly time-stamped. Therefore, the temporal relationship may be calculated by the time-stamp when the captured image data was recorded by the image capture device 10.

As described earlier, based on the received inputs from the information utility evaluation module 14 and the network status estimation module 16, the processor 12 determines the level of compression that is applied to the captured scene data. A fundamental assumption in determining the utility value utilizing the spatial relationship is that the greater the distance between the location of the event (e.g., traffic accident, congestion, or scenic event) and the current location of the remote vehicle, the less importance the event is to the remote vehicle. It should be understood that the captured event is not restricted to safety events, but may include any event that the source entity desires to pass along to the remote vehicle such as, but not limited to, location base service video or image/video of tourism attractions. With respect to the temporal relationship, a fundamental assumption in determining the utility value utilizing the temporal relationship is the longer the time difference between the captured event and the current time, the less importance the event is to the remote vehicle. The utility value is jointly determined as a function of the spatial relationship and the temporal relationship for applying compression and can be represented by the following formula:

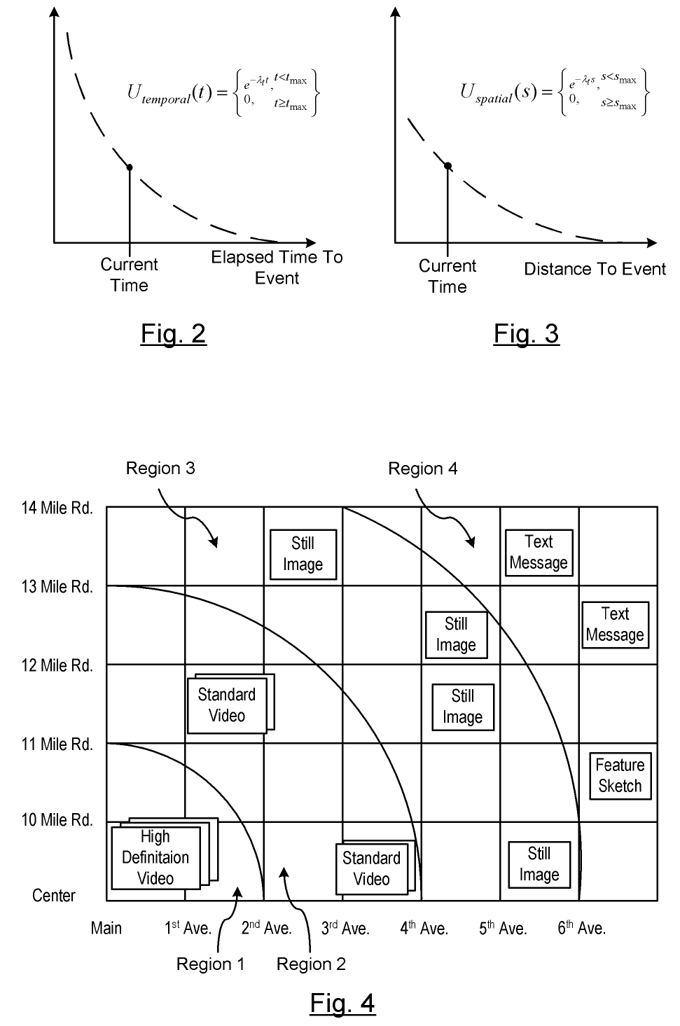

U(t,s)=f(Uₜₑₘₚₒᵣₐₗ(t)Uₛₚₐₜᵢₐₗ(s)) (1)

where Uₜₑₘₚₒᵣₐₗ is the temporal relationship, and Uₛₚₐₜᵢₐₗ is the spatial relationship. FIGS. 2 and 3 illustrate an example of how the temporal relationship and the spatial relationship may be determined. FIG. 2 illustrates a graph used to determine the temporal relationship and is also represented by the following equation:

$${U}_{temporal} ( t ) = \{ \begin{matrix}{e}^{- {λ}_{t} t} , & t < {t}_{max} \\ 0 , & t \geq {t}_{max}\end{matrix} \} \qquad ( 2 )$$

where λₜ is predetermined by calibration engineers, tₘₐₓ is the maximum duration by which image data is still considered valid to interested users. FIG. 3 illustrates a graph used to determine the spatial relationship and is also represented by the following equation:

$${U}_{spatial} ( s ) = \{ \begin{matrix}{e}^{- {λ}_{t} s} , & s < {s}_{max} \\ 0 , & s \geq {s}_{max}\end{matrix} \} \qquad ( 3 )$$

where λₛ is predetermined by calibration engineers, sₘₐₓ is the maximum range by which image data is still considered valid to interested users. It should be understood that the graphs shown in FIGS. 2 and 3 and the associated formulas are only exemplary and that the temporal relationship and spatial relationship may be determined by methods other than the graphs and associated formulas shown.

In addition to video compression of the scene data, the processor 12 may apply image abstraction to the scene data. Image abstraction includes extracting a still image from either the compressed video scene data or a still scene image may be extracted directly from captured video scene data. Image abstraction may further include decreasing the resolution and compression quality of the still image. In addition, if a smaller transmission size is required (e.g., in comparison to the video or still image data described above), a feature sketch of the extracted image may be generated through scene understanding techniques. Moreover, a text message may be transmitted instead of a still image or feature sketch (e.g., “accident at Center and Main”) by scene recognition techniques.

The network status estimation module 16 determines the network utilization parameter that involves a determination of the communication capabilities of the underlying communication network that includes, but is not limited to an available bandwidth. Preferably, the communication network is a Vehicular Ad hoc Network (VANET). A communication network status (represented in bits/second) may be estimated by evaluating four real-time measured metrics. The four metrics include a packet delivery ratio (PDR), a delay (\tilde{τ}(t)), jitter (\tilde{σ}(t)), and a throughput (\tilde{T}(t)). Each of the metrics is represented by the following recurring equations in which low-pass smoothing filters are engaged:

\tilde{P}(t)=α×P(t)+(1−α)×\tilde{P}(t−1), (4)

\tilde{τ}(t)=α×τ(t)+(1−α)×\tilde{τ}(t−1), (5)

\tilde{σ}(t)=α×σ(t)+(1−α)×\tilde{σ}(t−1), (6)

\tilde{T}(t)=α×T(t)+(1−α)×\tilde{T}(t−1). (7)

The network throughput parameter B(t) is represented by the following equation as a function of the four metrics described above. The equation representing the network utilization parameter B(t) is as follows:

B(t)=g(\tilde{P}(t),\tilde{τ}(t),\tilde{σ}(t),\tilde{T}(t). (8)

The function g( ) applied to the four metrics may be determined offline through machine learning that includes, but not limited to, support vector machine regression or random forest regression. To determine the function g( ), learned sets of network utilization parameters and metrics are input to a machine learner. The associated network utilization parameter and metrics are compiled as follows:

$$\begin{matrix}B ( {t}_{1} ) , ⌊ ( \tilde{P} ( {t}_{1} ) , \tilde{τ} ( {t}_{1} ) , \tilde{σ} ( {t}_{1} ) , \tilde{T} ( {t}_{1} ) ⌋ , & ( 9 ) \\ B ( {t}_{2} ) , ⌊ ( \tilde{P} ( {t}_{2} ) , \tilde{τ} ( {t}_{2} ) , \tilde{σ} ( {t}_{2} ) , \tilde{T} ( {t}_{2} ) ⌋ , & ( 10 ) \\ B ( {t}_{3} ) , ⌊ ( \tilde{P} ( {t}_{3} ) , \tilde{τ} ( {t}_{3} ) , \tilde{σ} ( {t}_{3} ) , \tilde{T} ( {t}_{3} ) ⌋ , & ( 11 ) \\ ⋮ & \\ B ( {t}_{n} ) , ⌊ ( \tilde{P} ( {t}_{n} ) , \tilde{τ} ( {t}_{n} ) , \tilde{σ} ( {t}_{n} ) , \tilde{T} ( {t}_{n} ) ⌋ . & ( 12 )\end{matrix}$$

The machine learner generates a function g( ) in response to the sets of network utilization parameter and associated metrics. The learned function g( ) is implemented in the network status estimation module 16 for determining the network utilization parameter using the formula identified in eq. (8). That is, for a set of measured metrics associated with the network communication for a remote vehicle, the metrics can be input to the function g( ) for calculating the network utilization parameter B(t) of the source vehicle. The network utilization parameter B(t) in cooperation with the utility value is used to determine the amount of compression and/or image abstraction that is applied to the captured scene data.

FIG. 4 illustrates an exemplary geographical grid identifying the scene information that may be transmitted to each respective geographical region within the grid based on the distance to the event. As shown in region 1, high quality video, such as high definition video, is preferably transmitted to remote vehicles in region 1 due to their close proximity to the event. High quality imaging is typically of greater value to the remote vehicle since the event could have a significant impact on the remote vehicle. In region 2, a lesser quality video in comparison to region 1 is preferably utilized, such as standard definition video. In region 3, due to the distance of the remote vehicle to the event, still images are preferably transmitted to remote entities located in region 3. The still images provide some details of the event, but due to the spatial relationship of the remote vehicle to the event, fine details of the event would typically not be required as this distance since the event may not have any impact on the remote vehicle due to the distance. For remote entities located in region 4 that are spaced a significant distance from the event, abstracted sketches or text messages may be transmitted, since there is a greater likelihood that the event will not impact the travel of the remote vehicle since the remote vehicle event may not even be on or near the intended course of travel of the remote vehicle.

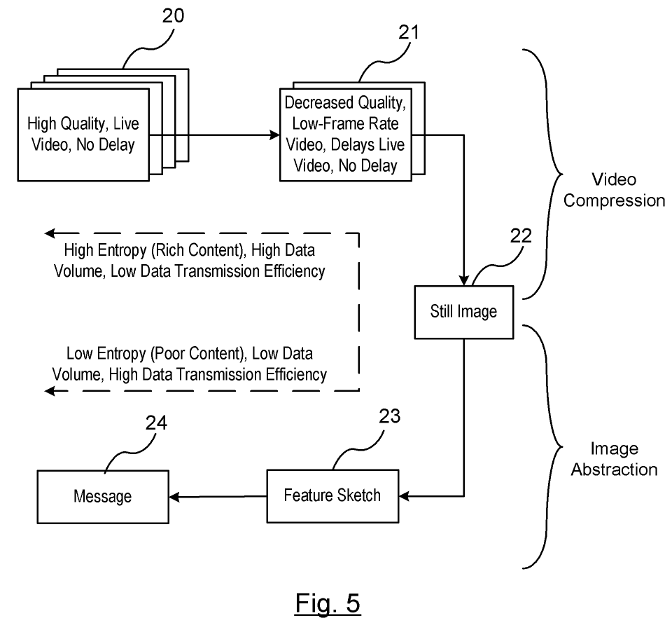

FIG. 5 illustrates the varying levels of scene quality that may be selected by the processor for compressing the captured scene data. In block 20 a high quality scene data would include live video having no delay. This may be viewed as capturing images having a large number of frames captured per second (e.g., 30 video frames/second). The larger the number of frames captured within a respective time frame, the higher the quality of the live video data. Under such quality conditions, either no compression or a very small amount of compression would be utilized.

In block 21, the quality and resolution of the video data is decreased by compressing the captured scene data. Under such conditions, a decrease in the frame video rate and image quality (e.g., 1 frame/sec) will reduce scene data size and have delays.

In block 22, a still image is extracted from the captured scene data through an image abstraction process. The extracted still image can be extracted from the compressed video or the captured scene data. The still image is a snapshot of one frame of the video data or compressed scene data. The resolution and compression quality of the still image can be varied as set forth by the utility value and the network utilization parameter.

In block 23, the transmitted data size of the still image may be lowered by generating a feature sketch from the still image. A feature sketch is a drawing/sketch that is representative of the captured event. The size of a data file for a feature sketch is greatly reduced in comparison to a still image.

In block 24, the size of the transmitted data file may be further reduced by transmitting only a message. The message describes the event taking place at the location of the event (e.g., “accident at Center and Main)).

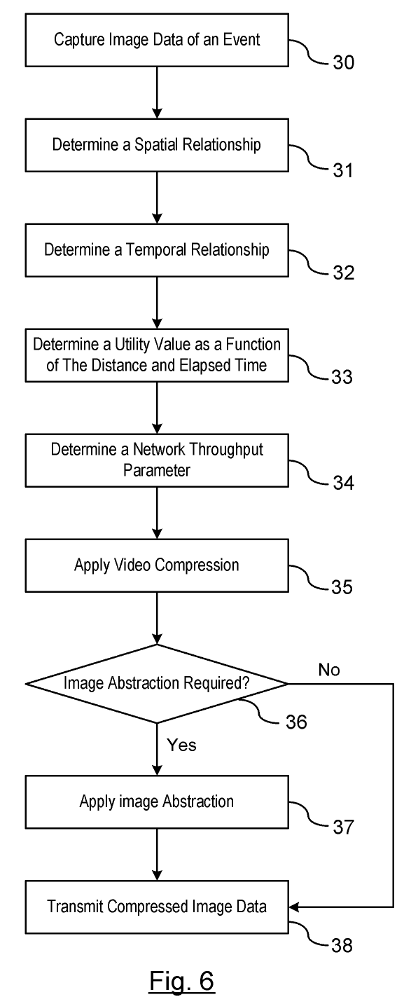

FIG. 6 is a flowchart for a method of the adaptive scene compression process for the vehicle-to-entity communication system. In step 30, an event is captured by an image capture device associated with the source entity. The image capture device is preferably a video imaging camera having capability of capturing high resolution video data. Alternatively, other types of imaging devices may be used.

In step 31, a distance is determined between a location of a remote vehicle and a location of the event where the event was captured by the image capture device.

In step 32, an elapsed time is determined since the time the event was captured by the image capture device.

In step 33, a utility value is determined. The utility value is determined as a function of the distance between the location of the remote vehicle and the location of the event, and as a function of the elapsed time since event was captured.

In step 34, a network utilization parameter of the communication network between the source entity and the remote vehicle is determined. The network utilization parameter of the wireless communication channel in addition to network utilization parameter of the receiving device is used to determine the network utilization parameter of the communication network.

In step 35, video compression is applied to the captured scene data. The amount of compression is determined as function of the available bandwidth and the utility value.

In step 36, a determination is made whether additional quality reduction is required after video compression is applied. If no further quality reduction is required, then the routine proceeds to step 38 wherein the compressed scene data is transmitted to the remote vehicle. If additional quality reduction is required, then the routine proceeds to step 37.

In step 37, image abstraction is applied to the compressed scene data where a still image is extracted from the compressed scene data. Image abstraction may further include generating a feature sketch from the still image or generating only a text message that describes the captured event. Alternatively, if compression using only image abstraction is required, then image abstraction may be applied directly to the captured image data as opposed to applying image abstraction to the compressed scene data.

In step 38, the compressed scene data is transmitted to the remote vehicle.

The advantage of the embodiments described herein is that quality of the scene data can be adaptively altered from its captured data form based on the network utilization parameter and a utility value which is determined as a function of the spatial and temporal relationship. An event that occurs within close proximity to the remote vehicle and within a short time frame from when the event occurred is more desirable to receive such scene data with high quality thereby providing greater details of the event since the event would be of greater significance to the remote vehicle. Events that are stale (i.e., significant amount of time has elapsed since the event is captured) and significantly distanced from the remote vehicle would be of less importance to the remote vehicle. Therefore, by taking into consideration the distance to the event and the time elapsed since the event was captured, in addition to the network utilization capabilities, the degree as to the quality of the scene data can be adaptively modified accordingly.

While certain embodiments of the present invention have been described in detail, those familiar with the art to which this invention relates will recognize various alternative designs and embodiments for practicing the invention as defined by the following claims.

What is claimed is:

1. A method for scene information sharing in a vehicle-to-entity communication system, the method comprising the steps of:
capturing scene data by an image capture device of an event in a vicinity of a source entity;
determining a spatial relationship between a location corresponding to the captured event and a location of a remote vehicle;
determining a temporal relationship between a time-stamp of the captured scene data and a current time;
determining a utility value as a function of the spatial relationship and the temporal relationship;
determining a network utilization parameter of a communication network for transmitting and receiving the scene data;
applying a selected level of compression to the captured scene data as a function of the utility value and available bandwidth; and
transmitting the compressed scene data from the source entity to the remote vehicle.

2. The method of claim 1 wherein applying a selected level of compression to the captured scene data includes applying video compression to the captured scene data.

3. The method of claim 2 further comprising the step of applying image abstraction to the compressed scene data, wherein image abstraction includes extracting a still image from the compressed scene data.

4. The method of claim 1 wherein applying a selected level of compression to the captured scene data includes applying image abstraction to the captured scene data, wherein image abstraction includes extracting a still image from the captured scene data.

5. The method of claim 1 wherein applying a selected level of compression to the captured scene data includes applying image abstraction to the captured scene data, wherein image abstraction includes generating a feature sketch from the still image.

6. The method of claim 1 wherein determining the network utilization parameter of the communication network includes determining a utilization parameter of a communication channel.

7. The method of claim 1 wherein determining the network utilization parameter of the communication network includes determining a utilization parameter of a receiving device of the remote vehicle.

8. The method of claim 1 wherein determining the network utilization parameter of the communication network utilizes a performance history of the communication network, wherein the performance history is based on a function of a packet delivery ratio, a latency, a jitter, and a throughput of previous broadcast messages.

9. The method of claim 1 wherein applying compression includes varying a level of granularity of the captured video data.

10. The method of claim 1 wherein an applied compression to the captured video data is based on a selected entropy.

11. The method of claim 1 wherein the network utilization parameter is determined offline by a machine learning technique.

12. A vehicle-to-entity communication system having adaptive scene compression for video sharing between a source entity and a remote vehicle, the system comprising:
an image capture device of the source entity for capturing video scene data of an event in a vicinity of the source entity;
an information utility module for determining a utility value that is a function of a spatial relationship between a location corresponding to the captured event and a location of the remote vehicle and a temporal relationship between a time-stamp of the captured scene data and a current time;
a network status estimation module for determining a network utilization parameter of a communication network;
a processor for applying a selected amount of compression to the captured scene data as a function of the utility value and the network utilization parameter of the communication network; and
a transmitter for transmitting the compressed scene data to the remote vehicle.

13. The system of claim 1 wherein the processor applying a selected level of compression to the captured scene data includes the processor applying video compression to the captured scene data.

14. The system of claim 14 wherein the processor applies image abstraction to the compressed scene data, wherein the applied image abstraction by the processor extracts a still image from the compressed scene data.

15. The system of claim 13 wherein the processor applying a selected amount of compression to the captured scene data includes the processor applying image abstraction to the captured scene data, wherein the applied image abstraction by the processor extracts a still image from the captured scene data.

16. The system of claim 13 wherein the processor generates a feature sketch from the captured scene data.

17. The system of claim 13 wherein the processor generates a message relating to the event occurring in the still image.

18. The system of claim 13 wherein communication network includes a wireless communication channel, wherein the network utilization parameter of the communication channel is determined by the network status estimation module.

19. The system of claim 13 wherein communication network includes a receiving device of the remote vehicle, wherein the network utilization parameter of the receiving device is determined by the network status estimation module.

20. The system of claim 1 wherein the network status estimation module utilizes a performance history of the communication network, wherein the performance history is a function of a packet delivery ratio, latency, jitter, and a throughput of previous broadcast messages.

21. The method of claim 1 further comprising a machine learning module for estimating the network utilization parameter.
